(19) United States
(12) Patent Application Publication
(10) Pub. No.: US 2021/0278507 A1
(43) Pub. Date: Sep. 9, 2021

(54) LIDAR SYSTEM INCLUDING OPTICAL FIBERS SELECTIVELY ILLUMINATING PORTIONS OF FIELD OF VIEW

(71) Applicant: Continental Automotive Systems, Inc., Auburn Hills, MI (US)

(72) Inventor: Ryan C. Stafford, Arroyo Grande, CA (US)

(73) Assignee: Continental Automotive Systems, Inc., Auburn Hills, MI (US)

(21) Appl. No.: 16/808,316

(22) Filed: Mar. 3, 2020

(51) Int. Cl. G01S 7/481; G01S 17/89; G01S 17/931; G01S 7/48

(52) U.S. Cl. CPC G01S 7/4817; G01S 17/89; G01S 7/4818; G01S 7/4804; G01S 7/4815; G01S 17/931

(57) ABSTRACT

A Lidar system includes an array of photodetectors, a fiber laser, and an optical switch connected to the fiber laser. An array of optical fibers is connected to the optical switch. At least some of the optical fibers of the array of optical fibers are aimed into different fields of illumination each positioned to be detected by a different segment of the array of photodetectors. Each segment of the array of photodetectors is smaller than the array of photodetectors.

### BACKGROUND

A solid-state Lidar system includes a photodetector, or an array of photodetectors, essentially fixed in place relative to a carrier, e.g., a vehicle. Light is emitted into the field of view of the photodetector and the photodetector detects light that is reflected by an object in the field of view. For example, a Flash Lidar system emits pulses of light, e.g., laser light, into essentially the entire field of view. The time of flight of the reflected photon detected by the photodetector is used to determine the distance of the object that reflected the light.

As an example, the solid-state Lidar system may be mounted on a vehicle to detect objects in the environment surrounding the vehicle and to detect distances of those objects for environmental mapping. The detection of reflected light is used to generate a 3D environmental map of the surrounding environment. The output of the solid-state Lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

### BRIEF DESCRIPTION OF THE DRAWINGS

FIG. 1 is a perspective view of a vehicle having a Lidar system each aimed forward at objects in the fields of view.

FIG. 2 is a perspective view of the Lidar system with a field of view and a field of illumination overlapping a portion of the field of view.

FIG. 3 is a perspective view of the Lidar system with the field of illumination moved to a different portion of the field of view.

FIG. 4 is a schematic view of the array of photodetectors divided into segments corresponding to positions of a field of illumination.

FIG. 5A is a schematic view of the array of photodetectors of FIG. 4 with one of the segments illuminated by the field of illumination.

FIG. 5B is a schematic view of the array of photodetectors of FIG. 4 with another of the segments illuminated by the field of illumination.

FIG. 5C is a schematic view of the array of photodetectors of FIG. 4 with another of the segments illuminated by the field of illumination.

FIG. 6 is a perspective view of an embodiment of the Lidar system including a light emitter, an optical switch connected to the light emitter, an array of optical fibers connected to the optical switch, and a lights sensor.

FIG. 7 is a perspective view of a light sensor.

FIG. 7A is a magnified view of FIG. 7A showing an array of photodetectors.

FIG. 8 is a perspective view of a vehicle having another example of the Lidar system including two fields of illumination on the field of view.

FIG. 9 is a perspective view of the Lidar system of FIG. 8 including one light sensor and a pair of light emitters, optical switches, and arrays of optical fibers.

FIG. 10 is a perspective view of another embodiment of the Lidar system including two light sensors each having a corresponding array of optical fibers, and a light emitter and switch connected to both array of optical fibers.

FIG. 11 is a top view of a vehicle including the Lidar system of FIG. 10.

FIG. 12 is a schematic of the Lidar system of FIG. 6.

FIG. 13 is a method performed by the Lidar system.

### DETAILED DESCRIPTION

With reference to the Figures, wherein like numerals indicate like parts throughout the several views, a system 10 includes an array 12 of photodetectors 14. The system 10 includes a light emitter 16, e.g., an optical fiber laser, and an optical switch 18 connected to the optical fiber laser. The system 10 includes an array 20 of optical fibers 22 connected to the optical switch 18. At least some of the optical fibers 22 of the array 20 of optical fibers 22 are aimed into different fields of illumination (FOI) each positioned to be detected by a different segment 24 of the array 12 of photodetectors 14. Each segment 24 of the array 12 of photodetectors 14 is smaller than the array 12 of photodetectors 14.

The system 10 includes a computer 26 having a processor and memory storing instructions executable by the processor. The instructions include instructions to supply light to the optical switch 18, adjust the optical switch 18 to selectively illuminate different ones of the array 20 of optical fibers 22, and detect light reflected in the FOI with the photodetectors 14.

Accordingly, the optical switch 18 scans the FOI to illuminate the field of view (FOV) of the array 12 of photodetectors 14 in segments 24, i.e., the segments 24 are individually distinct from each other. These segments 24 can be combined into a single frame corresponding to the entire FOV of the array 12 of photodetectors 14. This results in increased design flexibility and efficiencies for the light emitter 16, e.g., the optical fiber laser. For example, the light emitter 16 uses less power per flash and such light emitters 16 are easier to produce and power. By aiming the light with the optical switch 18 at different segments 24 of the array 12 of photodetectors 14, a larger FOV may be illuminated with a smaller light emitter 16.

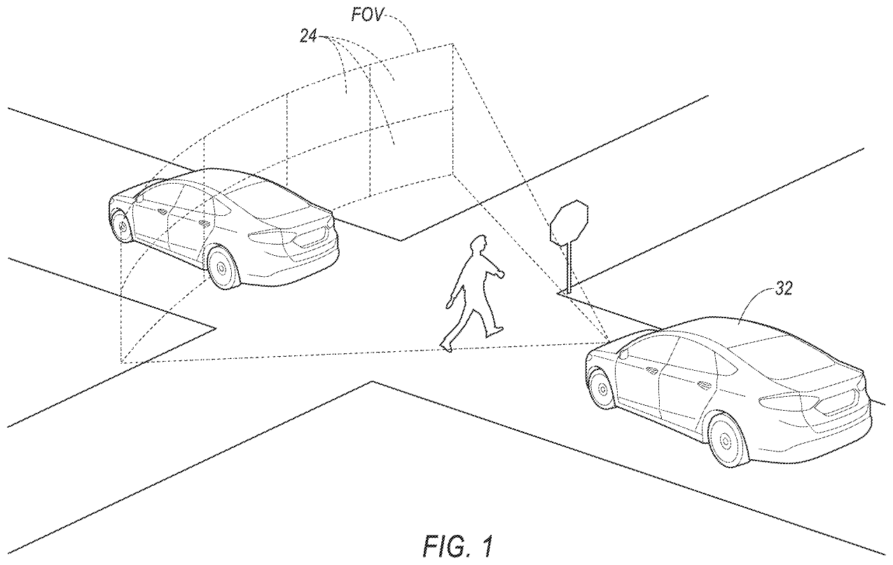

With reference to FIG. 1, the Lidar system 10 emits light and detects the emitted light that is reflected by an object, e.g., pedestrians, street signs, vehicles, etc. Specifically, the system 10 includes at least one light-transmission system 28 and at least one light-receiving system 30. The light-transmission system 28 includes the light emitter 16 that emits light for illuminating objects for detection. The FOV of the light-receiving system 30 overlaps the FOI and the light-receiving system 30 receives light reflected by objects in the FOV.

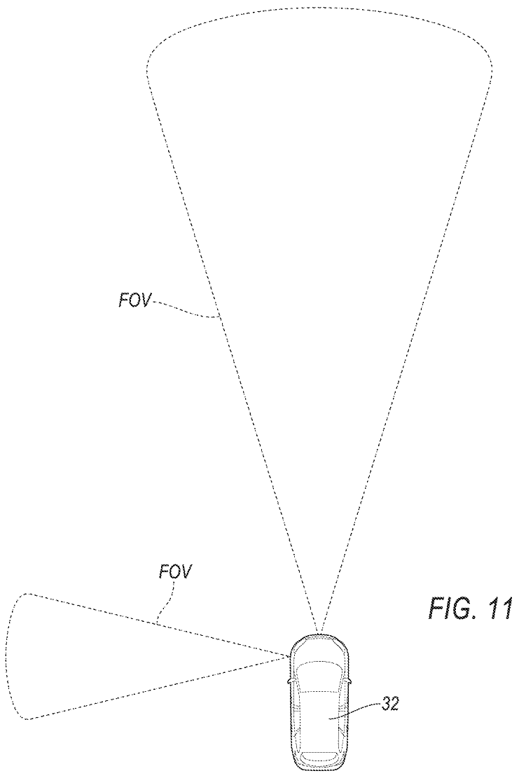

The Lidar system 10 is shown in FIG. 1 as being mounted on a vehicle 32. In such an example, the Lidar system 10 is operated to detect objects in the environment surrounding the vehicle 32 and to detect distance, i.e., range, of those objects for environmental mapping. The output of the Lidar system 10 may be used, for example, to autonomously or semi-autonomously control operation of the vehicle 32, e.g., propulsion, braking, steering, etc. Specifically, the Lidar system 10 may be a component of or in communication with an advanced driver-assistance system (ADAS) of the vehicle 32. The Lidar system 10 may be mounted on the vehicle 32 in any suitable position and aimed in any suitable direction. As one example, the Lidar system 10 in FIGS. 1-3 is shown on the front of the vehicle 32 and directed forward. As another example, the Lidar system 10 in FIGS. 10 and 11 is shown on both the front of the vehicle 32 and the side of the vehicle 32 and is aimed both forward and to the side. The vehicle 32 may have more than one Lidar system 10 and/or the vehicle 32 may include other object detection systems, including other Lidar systems. The vehicle 32 shown in the Figures is a passenger automobile. As other examples, the vehicle 32 may be of any suitable manned or un-manned type including a plane, satellite, drone, watercraft, etc.

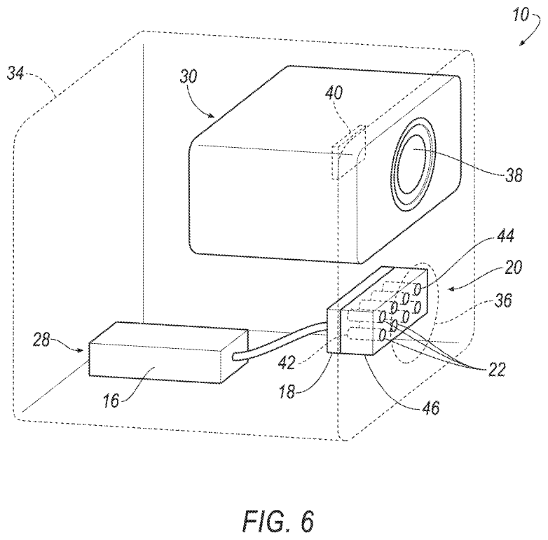

The Lidar system 10 may be a solid-state Lidar system. In such an example, the Lidar system 10 is stationary relative to the vehicle 32. For example, the Lidar system 10 may include one or more casing 34 (shown in FIGS. 6, 9, 11 and described below) that is fixed relative to the vehicle 32, i.e., does not move relative to the component of the vehicle 32 to which the casing 34 is attached. The casing 34 supports and encloses some or all components of the light-transmission system 28 and/or the light-receiving system 30.

As a solid-state Lidar system, the Lidar system 10 may be a flash Lidar system. In such an example, the Lidar system 10 emits pulses, i.e., flashes, of light into the field of illumination FOI. More specifically, the Lidar system 10 may be a 3D flash Lidar system that generates a 3D environmental map of the surrounding environment. In a flash Lidar system, an FOI illuminates at least a portion of an FOV that includes more than one photodetector 14, e.g., a 2D array, even if the illuminated 2D array is not the entire 2D array of a light sensor 40.

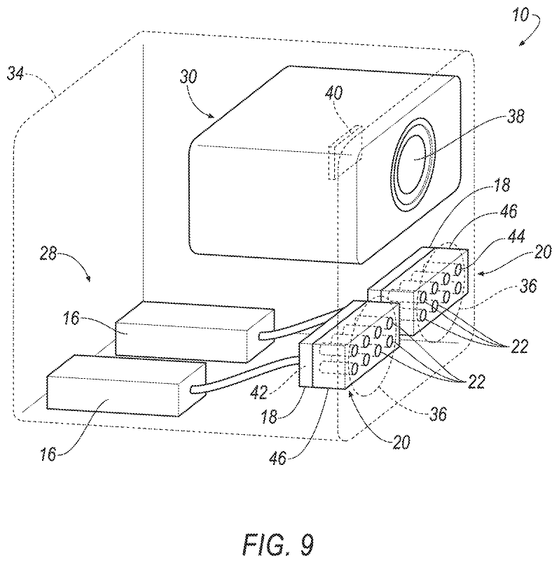

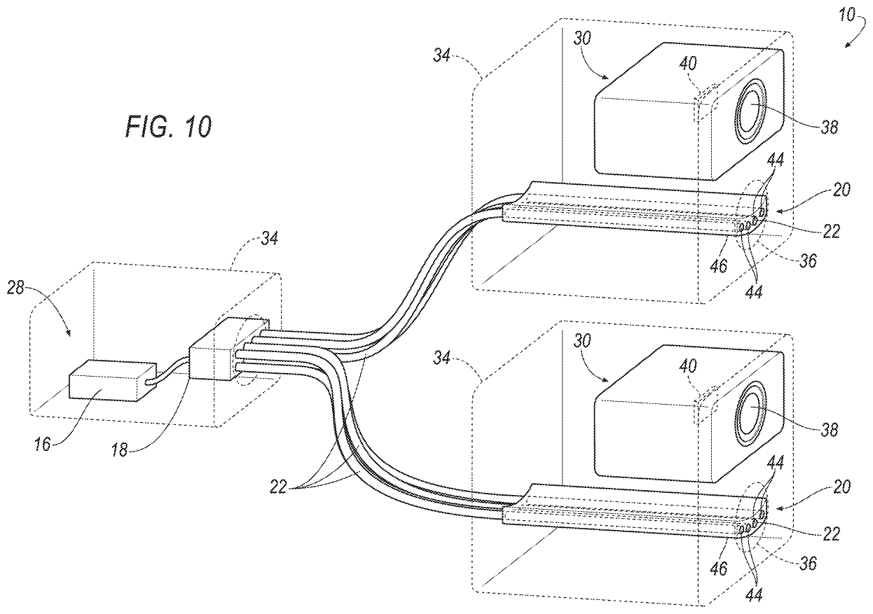

With reference to FIGS. 6, 9, and 10, the Lidar system 10 may be a unit. As examples shown in FIGS. 6 and 9, the light-transmission system 28 and the light-receiving system 30 enclosed by the casing 34. As another example, the system 10 of FIG. 10 has multiple casings 34 each enclosing components of the light-transmission system 28 and the light-receiving system 30. In either example, the casing 34 may include mechanical attachment features to attach the casing 34 to the vehicle 32 and electronic connections to connect to and communicate with electronic system 10 of the vehicle 32, e.g., components of the ADAS. An exit window 36 of the light-transmission system 28 and/or a receiving window 38 of the light-receiving system 30 extends through the casing 34. The exit window 36 and the receiving window 38 each include an aperture extending through the casing 34 and may include a lens or other optical device in the aperture.

The casing 34, for example, may be plastic or metal and may protect the other components of the Lidar system 10 from moisture, environmental precipitation, dust, etc. In the alternative to the Lidar system 10 being a unit, components of the Lidar system 10, e.g., the light-transmission system 28 and the light-receiving system 30, may be separated and disposed at different locations of the vehicle 32.

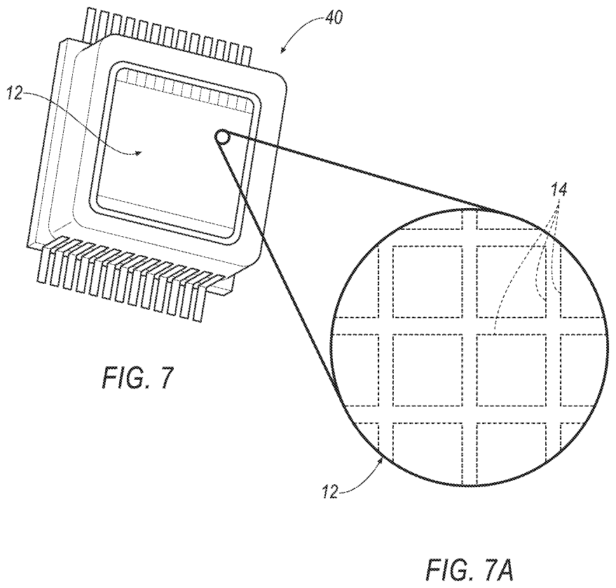

As set forth above, the light-receiving system 30 includes the light sensor 40. The light sensor 40 includes the array 12 of photodetectors 14, i.e., a photodetector array. The light sensor 40 includes a chip and the array 12 of photodetectors 14 is on the chip. The chip may be silicon (Si), indium gallium arsenide (InGaAs), germanium (Ge), etc., as is known. The chip and the photodetectors 14 are shown schematically in FIG. 7A. The array is 2-dimensional. Specifically, the array 12 of photodetectors 14 includes a plurality of photodetectors 14 arranged in a columns and rows. Each photodetector 14 is light sensitive. Specifically, each photodetector 14 detects photons by photo-excitation of electric carriers. An output signal from the photodetector 14 indicates detection of light and may be proportional to the amount of detected light. The output signals of each photodetector 14 are collected to generate a scene detected by the photodetector 14. The photodetectors 14 may be of any suitable type, e.g., photodiodes (i.e., a semiconductor device having a p-n junction or a p-i-n junction) including avalanche photodiodes, metal-semiconductor-metal photodetectors 14, phototransistors, photoconductive detectors, phototubes, photomultipliers, etc. As an example, the photodetectors 14 may each be a silicon photomultiplier (SiPM). As another example, the photodetectors 14 may each be or a PIN diode. Each photodetector 14 may also be referred to as a pixel. The light-receiving system 30 includes at least one light sensor 40. In examples including more than one light sensor 40, the light sensors 40 may be identical or different.

The light-receiving system 30 may include receiving optics (not shown). The light-receiving system 30 may include the receiving window 38, as described above, and the receiving optics may be between the receiving window 38 and the array 12 of photodetectors 14. The receiving optics may be of any suitable type and size.

The light-transmission system 28 includes the exit window 36, as described above, and includes the optical switch 18 is between the light emitter 16 and the exit window 36. The computer 26 is in communication with the light emitter 16 for controlling the emission of light from the light emitter 16 and the computer 26 is in communication with the optical switch 18 for aiming the emission of light from the Lidar system 10.

The light-transmission system 28 may include transmission optics (not shown) between the optical fibers 22 and the exit window 36. The transmission optics may be optics for focusing light, diffusing light, etc. The transmission optics shape the light that ultimately exits through the exit window 36 to the field of illumination FOI.

In examples including transmission optics, the light emitter 16 is aimed at the transmission optics. For example, the optical fibers 22 are aimed at the transmission optics, i.e., substantially all of the light emitted from the light emitter 16 reaches the transmission optics. The transmission optics direct the light, e.g., in the casing 34 from the optical fibers 22 to the exit window 36, and shapes the light. The transmission optics may include an optical element, a collimating lens, etc. In examples including the optical element, the optical element shapes light that is emitted from the light emitter 16. As one example of shaping the light, the optical element diffuses the light, i.e., spreads the light over a larger path and reduces the concentrated intensity of the light. In other words, the optical element is designed to diffuse the light from the optical fibers 22. As another example, the optical element scatters the light, e.g., a hologram). Light from the optical fibers 22 may travel directly from the optical fibers 22 to the optical element or may interact with additional components between the optical fibers 22 and the optical element. The shaped light from the optical element may travel directly to the exit window 36 or may interact with additional components between the optical element the exit window 36 before exiting the exit window 36 into the field of illumination FOI.

In examples including an optical element, the optical element directs the shaped light to the exit window 36 for illuminating the field of illumination FOI exterior to the Lidar system 10. In other words, the optical element is designed to direct the shaped light to the exit window 36, i.e., is sized, shaped, positioned, and/or has optical characteristics to direct the shaped light to the exit window 36. The optical element may be of any suitable type that shapes and directs light from the light emitter 16 toward the exit window 36. For example, the optical element may be or include a diffractive optical element, a diffractive diffuser, a refractive diffuser, a computer-generated hologram, a blazed grating, etc. The optical element may be reflective or transmissive.

The light emitter 16 emits light for illuminating the FOI for detection by the light-receiving system 30 when the light is reflected by an object in the field of view FOV. Specifically, the light emitter 16 supplies light to the optical switch 18 and the optical switch 18 passes the light to a selected one of the optical fibers 22. The light emitter 16 may be, for example, a laser. The light emitter 16 may be, for example, a semiconductor laser. For example, the light emitter 16 may be a diode-pumped solid-state laser (DPSSL). Specifically, the DPSSL may be an optical fiber laser. In an optical fiber laser, the active gain medium is an optical fiber 22 doped with rare-earth elements such as erbium, ytterbium, neodymium, dysprosium, praseodymium, thulium, and/or holmium.

The light emitter 16 may be designed to emit a pulsed flash of light, e.g., a pulsed laser light. Specifically, the light emitter 16, e.g., the optical fiber laser, is designed to emit a pulsed laser light. The light emitted by the light emitter 16 may be, for example, infrared light. Alternatively, the light emitted by the light emitter 16 may be of any suitable wavelength. The Lidar system 10 may include any suitable number of light emitters 16. For example, the Lidar system 10 of FIGS. 6 and 10 include one light emitter 16, e.g., one optical fiber laser. As another example, the Lidar system 10 of FIG. 9 includes two light emitters 16, e.g., two optical fiber lasers. In examples that include more than one light emitter 16, the light emitters 16 may be identical or different.

The light emitter 16 may be stationary relative to the casing 34. In other words, the light emitter 16 does not move relative to the casing 34 during operation of the system 10, e.g., during light emission. The light emitter 16 may be mounted to the casing 34 in any suitable fashion such that the light emitter 16 and the casing 34 move together as a unit.

The Lidar system 10 may include one or more cooling devices for cooling the light emitter 16. For example, the system 10 may include a heat sink on the casing 34 adjacent the light emitter 16. The heat sink may include, for example, a wall adjacent the light emitter 16 and fins extending away from the wall exterior to the casing 34 for dissipating heat away from the light emitter 16. The wall and/or fins, for example, may be material with relatively high heat conductivity. The light emitter 16 may, for example, abut the wall to encourage heat transfer. In addition or in the alternative, the fins, the system 10 may include additional cooling devices, e.g. thermal electric coolers (TEC).

As set forth above, the light-transmission system 28 includes the array 20 of optical fibers 22. Each optical fiber 22 is connected to the optical switch 18 and is selectively illuminated by the light emitter 16 through the optical switch 18. In other words, the optical switch 18 selects which optical fiber 22 (or grouping of less than all of the optical fibers 22) is illuminated by the light emitter 16. Each of the optical fibers 22 is operatively connected to the optical switch 18 to receive light from the optical switch 18 when the optical switch 18 selects the optical fiber 22 for illumination.

The optical fibers 22 transmit light. Specifically, one of the optical fibers 22 illuminated by the light emitter 16 through the optical switch 18 transmits light from an illuminated end 42 connected to the optical switch 18 to an illuminating end 44. Light is transmitted through the illuminating end 44 into the FOV. The optical fibers 22 may be of any suitable material, e.g., silica, plastic, etc. The optical fibers 22 may include a core and a cladding surrounding the core and having a lower index of refraction than the core.

At least some of the optical fibers 22 of the array 20 of optical fibers 22 are aimed into different FOI each positioned to be detected by a different segment 24 of the array 12 of photodetectors 14. The illuminating end 44 of the optical fibers 22 are fixed relative to each other. As an example, the optical fibers 22, e.g., at least at the illuminating end 44, may be fixed to a substrate 46 to fix the position of the optical fibers 22 relative to each other, i.e., to fix the FOIs of the optical fibers 22 relative to each other. The optical fibers 22 are embedded in the substrate 46. As an example, the optical fibers 22, at least at the illuminating ends 44, may be glued to the substrate 46. As another example, the optical fibers 22, at least at the illuminating ends 44, may be overmolded by the substrate 46, i.e., the substrate 46 is molded onto the illuminating ends 44. The illuminating ends 44 are exposed at the substrate 46 so that light emitted from the illuminated ends 44 is unobstructed by the substrate 46. The substrate 46 may be in the casing 34 and/or may be external to the casing 34. In other words, the substrate 46 may be entirely in the casing 34, as shown in the example in the Figures, may be entirely external to the casing 34, or may be both internal to the casing 34 and external to the casing 34.

The substrate 46 may be plastic or any suitable material. In other words, the substrate 46 may be a block, e.g., a block of plastic. The substrate 46 may be rigid relative to the optical fibers 22 to fix location of the illuminating ends 44 relative to each other. The substrate 46 is fixed to the casing 34, i.e., does not move relative to the substrate 46. As examples, the substrate is fixed to the casing 34, for example, with fasteners, adhesives, etc.

The substrate 46 may curve, as shown in FIG. 10. This may be used to accomplish vehicle styling and design constraints (e.g., to match external contours of a vehicle body), packaging constraints in the casing 34, and/or packaging constraints of the vehicle 32 external to the casing 34. The optical fibers 22 may follow the curve of the substrate 46, as shown in FIG. 10, to position the illuminating ends 44 in a desired position (to accomplish the vehicle styling and design constraints, packaging constraints, etc.) The optical fibers 22 in the substrate 46 may be straight, as shown in the Figures, or may curve to guide the path of the optical fibers 22 through the substrate 46.

The illuminating ends 44 may be arranged in linear rows and columns, as shown in FIGS. 6 and 9. As another example, the illuminating ends 44 may be arranged along a one or more curved paths, as shown in FIG. 10. The curved path may follow a curve in the substrate, as shown in FIG. 10 and described above. As other examples, the illuminating ends 44 may be arranged in any suitable arrangement relative to each other and relative to the shape of the substrate 46.

The FOI generated by each optical fiber 22 is smaller than the FOV of the array 12 of photodetectors 14. In other words, the FOI is positioned to be detected by a segment 24 (i.e., less than the whole) of the array 12 of photodetectors 14. The FOIs of all of the optical fibers 22, in combination, cover the entire FOV of the array 12 of photodetectors 14 so that the scenes detected by the array 12 of photodetectors 14 at each segment 24 can be combined into a frame including light detected in the entire FOV. The FOI may be of any suitable shape. In the example shown in the Figures, the FOI is rectangular. “Positioned to be detected” means that, if an object is in the FOI, the object reflects light back to the segment 24 of the array 12 of photodetectors 14. As described below, the optical switch 18 moves the FOI vertically to position and light is emitted at each position.

The optical fibers 22, specifically the illuminating ends 44, may be arranged in a pattern for illuminating the FOV by segment 24. As described further below, each optical fiber 22 is positioned to illuminate an FOI detected by a segment 24 of the array 12 of photodetectors 14. As an example, pattern may a grid that is linear and has more than one column and more than one row, as shown in the Figures. In the example shown in FIGS. 1-5C, the light-transmission system 28 may include eight optical fibers 22 illuminating eight segments 24. In other examples, the light-transmission system 28 may include any suitable number of optical fibers 22. In the examples including a grid, the grid may include any suitable number of columns and rows.

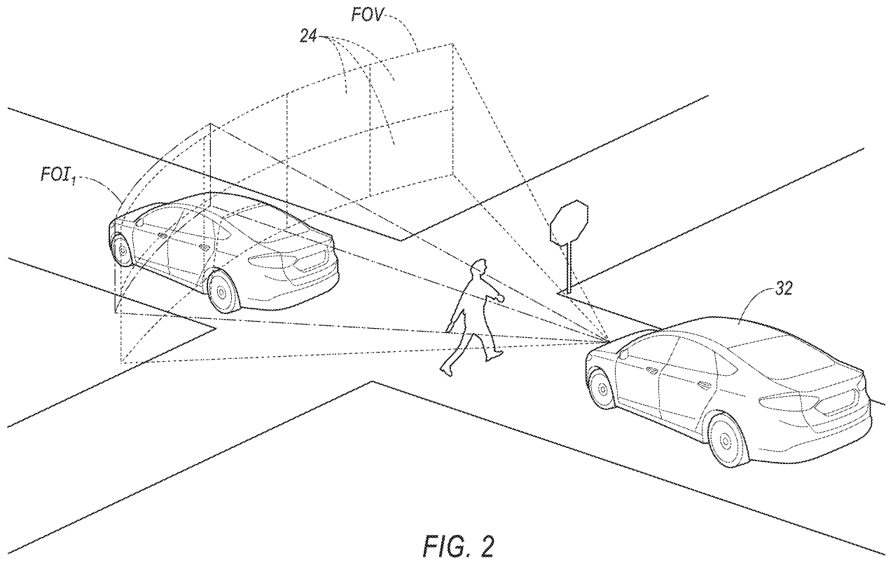

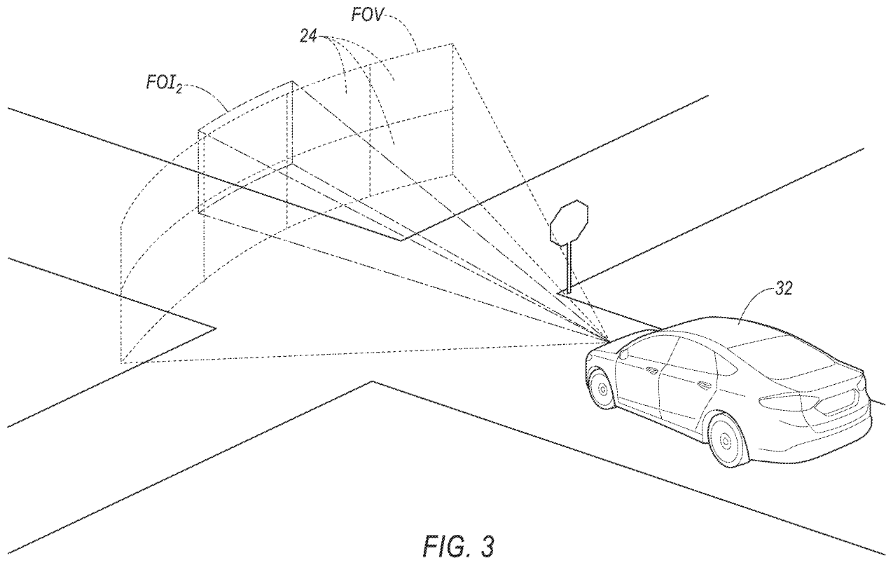

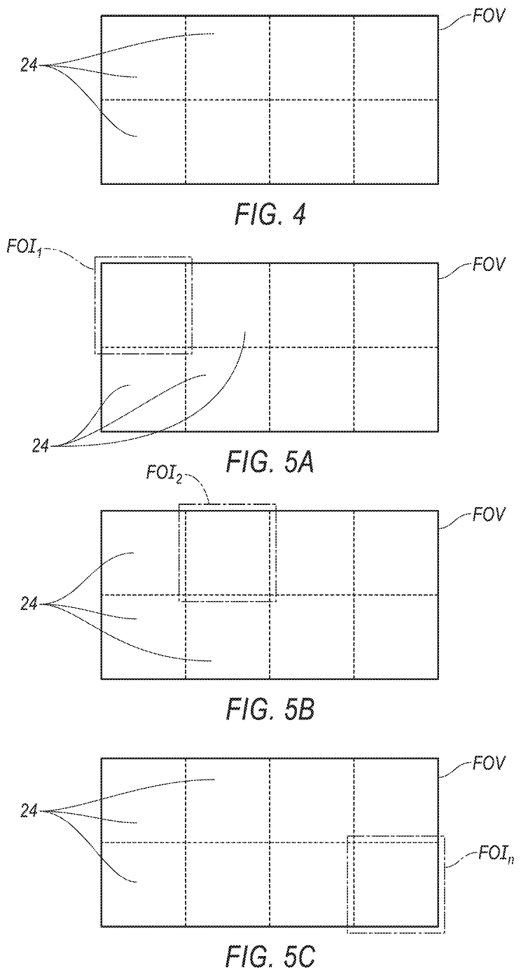

As shown in FIGS. 2-5C, illumination of different ones of the optical fibers 22 generate different FOIs detected by different segments 24 of the array 12 of photodetectors 14. Specifically, FIGS. 2 and 3 schematically show the FOV divided into segments 24. FIG. 2 shows the FOI1 from illumination of the one of the optical fibers 22₁ (identified in FIG. 6) and FIG. 2 shows the FOI2 from illumination of another one of the optical fibers 22₂ (identified in FIG. 6). FIG. 4 is a schematic view of the FOV of the of the array 12 of photodetectors 14 that is split into segments 24. FIG. 5A schematically shows the illumination of one of the segments 24₁ with the FOIA of one of the optical fibers 22₁. FIG. 5B schematically shows the illumination another of the segments 242 with the FOIB of one of the optical fibers 22₂. FIG. 5C schematically shows the illumination of another of the segments 24N with the FOIN of one of the optical fibers 22_{N}. As one example, the sequence may go across the top row of segments 24 and the across the bottom row of segments 24, e.g., left to right in FIGS. 5A-C.

The optical switch 18 switches the transmission of light from the light emitter 16 from one of the optical fibers 22 to another of the optical fibers 22. In other words, the optical switch 18 has a position, i.e., a channel, for each optical fiber 22 and the optical switch 18 switches positions to illuminate a selected one (or group of less than all) of the optical fibers 22. As examples, the optical switch 18 may be referred to as an optical space switch, an optical router, etc. The optical switch 18 is operatively connected to each optical fiber 22 to transmit light from the light emitter 16 to the selected optical fiber 22. The optical switch 18 is operatively connected to the light emitter 16, e.g., the optical fiber laser, to receive light from the light emitter 16 and transmit the light to the selected optical fiber 22. As an example, an optical fiber 22 may connect the light emitter 16 to the optical switch 18.

The optical switch 18 may include microelectromechanical systems (MEMS) mirrors to adjust the position of the optical switch 18. As another example, the optical switch 18 may be a wavelength switch. In such an example, the position, i.e., the channel, is chosen by wavelength of light entering the switch. In this example, the light emitter 16 may be operated to emit light at different wavelengths to control the position of the optical switch 18.

The optical switch 18 scans through a sequence of positions and illuminates a different one of the optical fibers 22 at each position. At each position, the FOI may be adjacent or overlapping the aim of the FOI of the previous position and the following position in the sequence. The light emitter 16 emits a flash of light at each position.

The optical switch 18 switches illumination between optical fibers 22 to move the FOI relative to the array 12 of photodetectors 14. For example, when the optical switch 18 is at the position producing the FOI shown in FIG. 5A, the FOI is aimed at one of the segments 24₁ of the array 12 of photodetectors 14. In other words, if light is reflected by an object in the FOI at the first position, the reflected light is detected by the segment 24₁ of the array 12 of photodetectors 14 Likewise, when the optical switch 18 is at the position producing the FOI shown in FIG. 5B, the FOI is aimed at one of the segments 242 of the array 12 of photodetectors 14. Each photodetector 14 of the array 12 of photodetectors 14 is illuminated 5ae in the combination of all positions of the optical switch 18.

In some examples, each photodetector 14 of the array 12 of photodetectors 14 remains operational at all positions of the optical switch 18. In such examples, in the event light is detected by a photodetector 14 outside of the segment 24 of the array 12 of photodetectors 14 at which the FOI is aimed, such a detection may be an indication that the Lidar system 10 is damaged or has detected light from a different source than the light emitter 16. In such an event, the Lidar system 10 may output a fault indication in response to such a detection and/or may discard the data so that the data is not used by the ADAS. In other examples, the array 12 of photodetectors 14 may be operated such that only the segment 24 of the array at which the FOI is aimed are operational to increase lifespan of the array 12 of photodetectors 14 and/or to reduce the amount of memory and reduce the amount of output bandwidth to a central processing unit.

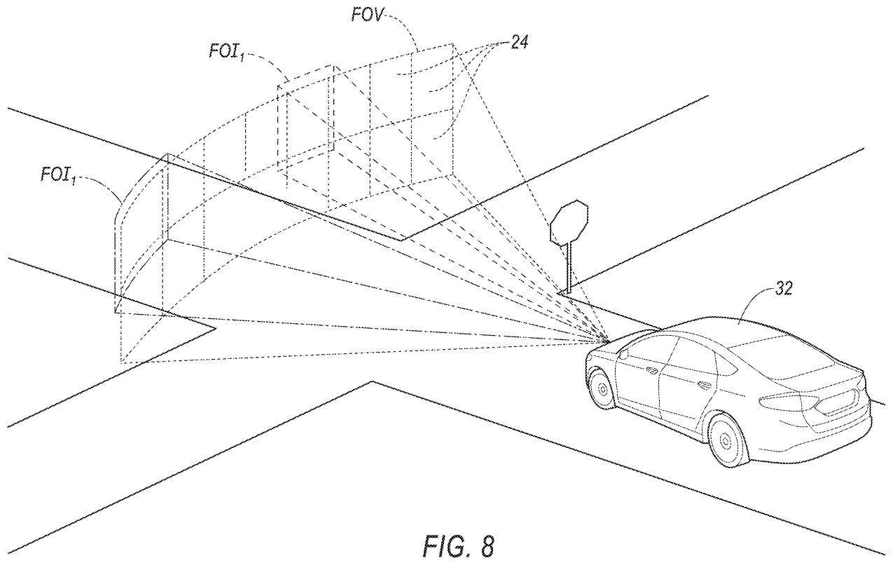

The Lidar system 10 may include more than one light sensor 40 and/or more than one light emitter 16. In such examples, the light sensors 40 may operate similarly to each other and/or may be identical to each other and the light emitters 16 may operate similarly to each other and/or may be identical to each other. The Lidar system 10 may include any suitable number of light sensors 40, light emitters 16, optical switches 18, arrays 20 of optical fibers 22, etc., and the configurations shown in FIGS. 8-11 are for example.

With reference to FIGS. 8 and 9, for example, the Lidar system 10 may include more than one light emitter 16, e.g., optical fiber laser, each illuminating different segments 24 of one array 12 of photodetectors 14. In the example shown in FIG. 9, the light-transmission system 28 includes more than one optical switch 18 and more than one array 20 of optical fibers 22. The arrays 20 of optical fibers 22 are aimed into different fields of illumination each positioned to be detected by a different segment 24 of the array 12 of photodetectors 14. The FOIs of the optical fibers 22 of the two arrays 20 of optical fibers 22 are different. As shown in FIG. 8, the light emitters 16 may operate simultaneously to illuminate different segments 24 of the array 12 of photodetectors 14.

With reference to FIGS. 10 and 11, for example, the Lidar system 10 may include more than one array 20 of optical fibers 22 aimed at more than one light sensor 40. Specifically, one array 20 of optical fibers 22 illuminate segments 24 of one array 12 of photodetectors 14 and the other array 20 of optical fibers 22 illuminates the segments 24 of another array 12 of photodetectors 14. The light-transmission system 28 of FIG. 10 includes one light emitter 16 and one optical switch 18. The optical switch 18 switches between the optical fibers 22 of both arrays of optical fibers 22.

As shown in FIGS. 10 and 11, the arrays of optical fibers 22 may be spaced from each other and the arrays of photodetectors 14 may be spaced from each other. Specifically, as shown in FIG. 11, the arrays of optical fibers 22 may be aimed in different directions and the arrays of photodetectors 14 may be aimed in corresponding directions. In FIG. 11, as an example, one pair of the array 20 of optical fibers 22 and the array 12 of photodetectors 14 is aimed forward of the vehicle 32 and another pair is aimed to the side of the vehicle 32. Accordingly, the one light emitter 16 illuminates a forward-facing FOV and a side-facing FOV. The optical switch 18 may operate to alternately illuminate one array 20 of optical fibers 22 and then the other array 20 of optical fibers 22, i.e., the optical switch 18 may operate to complete a sequence of positions including each optical fiber 22 of one of the arrays of optical fibers 22 and subsequently complete a sequence of positions including each optical fiber 22 of the other of the arrays of optical fibers 22.

In the examples in which the arrays of optical fibers 22 are spaced from each other, the arrays of optical fibers 22 may be in separate casings 34 located at separate areas of the vehicle 32. In such examples, the optical fibers 22 may be curved between the optical switch 18 and illuminating ends 44.

In any configuration, the optical fibers 22 may be curved between the optical switch 18 and the illuminating ends 44. This may be used to accommodate vehicle styling and design constraints (e.g., to match external contours of a vehicle body) and/or to accomplish packaging constraints (i.e., the optical fibers 22 may be snaked around other elements of the system 10 and/or other elements of the vehicle 32). For example, the optical fibers 22 may curve between the switch 18 and the block 46 and/or may curve in the block 46, both of which examples are shown in FIG. 10. The optical fibers 22 may curve within the casing 34. In examples in which the optical fibers 22 extend external to the casing 34, the optical fibers 33 may curve external to the casing 34.

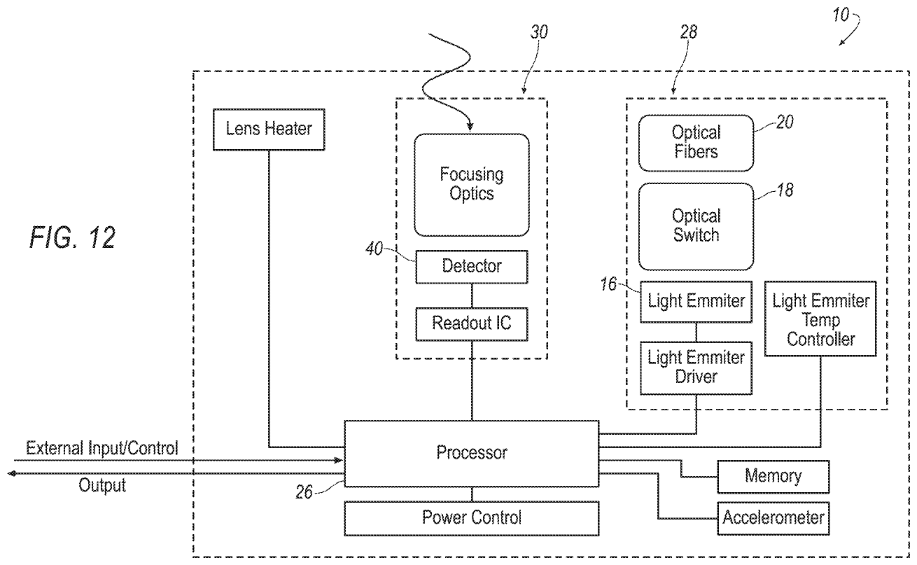

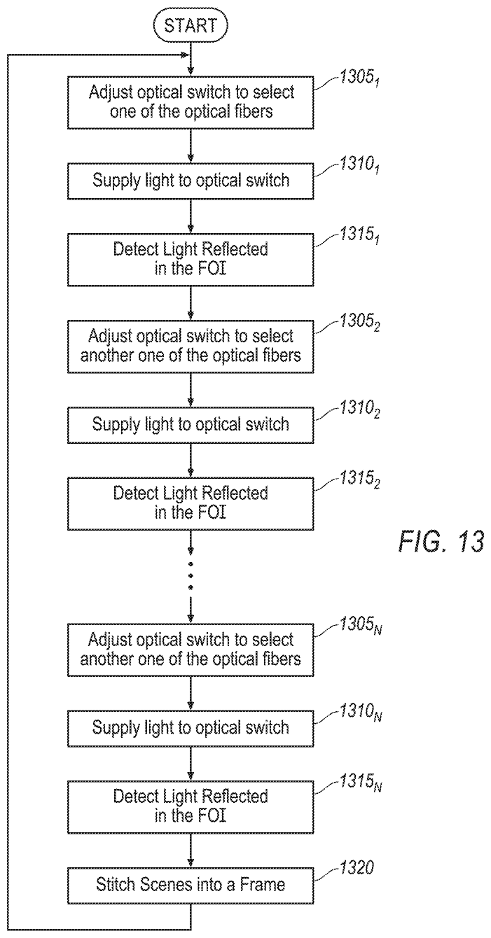

As set forth above, the computer 26 has a processor and a memory storing instructions executable by the processor to control the light emitter 16, the optical switch 18, and the light sensor 40. The computer 26 may be a microprocessor-based controller or field programmable gate array (FPGA), or a combination of both, implemented via circuits, chips, and/or other electronic components. In other words, the computer 26 is a physical, i.e., structural, component of the system 10. With reference to FIG. 12, the computer 26 includes the processor, memory, etc. The memory of the computer 26 may store instructions executable by the processor, i.e., processor-executable instructions, and/or may store data. The computer 26 may be in communication with a communication network of the vehicle 32 to send and/or receive instructions from the vehicle 32, e.g., components of the ADAS. The instructions stored on the memory of the computer 26 include instructions to perform the method in FIG. 13. Use herein (including with reference to the method in FIG. 13) of “based on,” “in response to,” and “upon determining,” indicates a causal relationship, not merely a temporal relationship.

With reference to FIG. 13, the memory stores instructions to adjust the optical switch 18 to move the FOI relative to the array 12 of photodetectors 14. Specifically, the memory stores instructions to adjust the optical switch 18 in the sequence of positions aimed at different ones of the optical fibers 22 and to emit light from the light emitter 16 at each position. As set forth above, the field of illumination is positioned to be detected by different segments 24 of the array 12 of photodetectors 14 at each position. The respective segment 24 of the array 12 of photodetectors 14 detects light reflected in the FOI. The memory stores instructions to cycle through the positions of the optical switch 18, emit light at each position, and detect reflected light at each position, i.e., detect the scene. In FIG. 13, the sequence includes N number of positions. The first position, second position, and N position correspond to FOI₁, FOI₂, and FOI_{N}, respectively, in FIGS. 5A-C. The memory stores instructions to stitch together scenes from adjacent ones of the segments 24 to form a frame. The frame is used to create a 3D environmental map and/or is output, e.g., to the ADAS.

With reference to block 1305₁ of FIG. 13, the memory stores instructions to adjust the FOI in the sequence by controlling operation of the optical switch 18 as described above. The memory stores instructions to adjust the optical switch 18 to selectively illuminate different ones of an array 20 of optical fibers 22. Specifically, the instructions include instructions to adjust the optical switch 18 to selectively connect light emitter 16, e.g., the optical fiber laser, with different ones of the optical fibers 22.

As shown in FIG. 13, the memory stores instructions to adjust the optical switch 18 in the sequence, as identified by blocks 1305₂ and 1305_{N}. As set forth above, when the optical switch 18 is in the position shown in FIG. 5A, for example, the FOI is aimed at one segment 241 of the array 12 of photodetectors 14. Likewise, when the optical switch 18 is in the position shown in FIG. 5B, the FOI is aimed at the segment 242 of the array 12 of photodetectors 14 and when the optical switch 18 is in the position shown in FIG. 5C, the FOI is aimed at segment 24 of the array 12 of photodetectors 14.

The memory stores instructions to adjust the optical switch 18 to deviate from the sequence of positions and return to one of the positions based on previous detection of light at that position. For example, in the event that a low amount of light is detected possibly indicating an object just out of range of the FOI, the optical switch 18 may return to that position, out of order of the sequence, to again emit light and detect reflection at that segment 24.

With reference to blocks 1310₁, 1310₂, and 1310_{N} of FIG. 13, the memory stores instructions to emit light from the light emitter 16 by controlling the operation of the light emitter 16. Specifically, the memory stores instructions to power the light emitter 16, e.g., the optical fiber laser. In other words, the memory stores instructions to first adjust the position of the optical switch 18 and subsequently power the light emitter 16.

With reference to blocks 1315₁, 1315₂, and 1315_{N} of FIG. 13, the memory stores instructions to detect light reflected in the FOI with a segment 24 of the array 12 of photodetectors 14. “Detecting” light may include detecting intensity and range. The memory may store instructions to operate the array 12 of photodetectors 14 as described above. As one example, the memory stores instructions to, at each position of the optical switch 18, operate the segment 24 of the array 12 of photodetectors 14 for which the field of illumination is positioned to be detected by and to disable the remaining photodetectors 14 of the array 12. In such examples, the memory stores instructions to, in response to detection of light by the photodetector 14 outside of the segment 24 of the array 12 of photodetectors 14 at which the FOI is aimed, indicate that the Lidar system 10 is damaged or has detected light from a different source than the light emitter 16. Specifically, the memory may store instructions to output a fault indication in response to such a detection and/or to discard the data so that the data is not used by the ADAS. In other examples, the memory may store instructions to operate each photodetector 14 of the array 12 of photodetectors 14.

The detection of light at each position of the optical switch 18 forms a scene at that position. With reference to block 1320, the memory stores instructions to stitch the scenes together to form a frame. The scenes may be stitched with any suitable software, method, etc. When stitched, overlapping portions of adjacent scenes may be merged or discarded to create continuity in the frame.

After the optical switch 18 is aimed at the final position in the sequence, i.e., N position in FIG. 5C, the memory stores instructions to repeat adjustment of the optical switch 18 to another sequence of positions. This next sequence of positions may be the same as the previous, as shown in FIGS. 5A-C. In other words, the memory may store instructions to adjust the optical switch 18 back to the first position (corresponding to FOI₁ in FIG. 5A). As another example, the memory may store instructions to reverse the sequence.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
an array of photodetectors;
a fiber laser;
an optical switch connected to the fiber laser;
an array of optical fibers connected to the optical switch, at least some of the optical fibers of the array of optical fibers being aimed into different fields of illumination each positioned to be detected by a different segment of the array of photodetectors, each segment of the array of photodetectors being smaller than the array of photodetectors.

2. The system as set forth in claim 1, further comprising a second fiber laser, a second optical switch connected to the second fiber laser, and a second array of optical fibers connected to the second optical switch, at least some of the optical fibers of the second array of optical fibers being aimed into different fields of illumination each positioned to be detected by a different segment of the array of photodetectors.

3. The system as set forth in claim 2, wherein the fields of illumination of the optical fibers of the second array of optical fibers are different than the fields of illumination of the optical fibers of the array of optical fibers.

4. The system as set forth in claim 1, further comprising a second array of photodetectors spaced from the array of photodetectors, at least some of the optical fibers of the array of optical fibers being aimed into different fields of illumination each positioned to be detected by a different segment of the second array of photodetectors, each segment of the second array of photodetectors being smaller than the second array of photodetectors.

5. The system as set forth in claim 4, wherein the array of photodetectors and the second array of photodetectors are aimed in different directions.

6. The system as set forth in claim 4, wherein at least some of the optical fibers of the array of optical fibers are curved.

7. The system as set forth in claim 1, further comprising an optical fiber connecting the fiber laser to the optical switch.

8. The system as set forth in claim 1, wherein the segments of the array of photodetectors and the array of optical fibers are each arranged in a grid having more than one row and more than one column.

9. The system as set forth in claim 1, further comprising a computer having a processor and memory storing instructions executable by the processor to adjust the optical switch to selectively connect the fiber laser with different ones of the optical fibers.

10. The system as set forth in claim 9, wherein the memory stores instructions executable by the processor to adjust the optical switch through a sequence of positions aimed different ones of the optical fibers and to emit light from the light emitter at each position.

11. The system as set forth in claim 9, wherein the memory stores instructions executable by the processor to adjust the optical switch so that each segment of the array of photodetectors is illuminated at least once in the sequence.

12. The system as set forth in claim 9, wherein the memory stores instructions executable by the processor to, at each position of the sequence, operate the segment of the array of photodetectors for which the field of illumination is positioned to be detected by and to disable the remaining photodetectors of the array of photodetectors.

13. A computer having a processor and memory storing instructions executable by the processor to:
supply light to an optical switch;
adjust the optical switch to selectively illuminate different ones of an array of optical fibers, at least some of the optical fibers being aimed into different fields of illumination each positioned to be detected by a different segment of an array of photodetectors, each segment of the array of photodetectors being smaller than the array of photodetectors; and
detect light reflected in the field of illumination with the photodetectors.

14. The computer as set forth in claim 13, wherein the memory stores instructions executable by the processor to adjust the optical switch through a sequence of positions aimed different ones of the optical fibers and to supply light to the optical switch at each position.

15. The computer as set forth in claim 14, wherein the memory stores instructions executable by the processor to adjust the optical switch so that each segment of the array of photodetectors is illuminated at least once in the sequence.

16. The computer as set forth in claim 14, wherein the memory stores instructions executable by the processor to, at each position of the sequence, operate the segment of the array of photodetectors for which the field of illumination is positioned to be detected by and to disable the remaining photodetectors of the array of photodetectors.

17. The computer as set forth in claim 14, wherein the memory stores instructions executable by the processor to adjust the optical switch to deviate from the sequence of positions and return to one of the positions based on previous detection of light at that position.

18. The computer as set forth in claim 13, wherein the memory stores instructions to detect a scene of light reflected in the field of illumination with each segment and stitch together the scenes from adjacent ones of the segments to form a frame.

19. A method comprising:
supplying light to an optical switch;
adjusting the optical switch to selectively illuminate different ones of an array of optical fibers, at least some of the optical fibers being aimed into different fields of illumination each positioned to be detected by a different segment of an array of photodetectors, each segment of the array of photodetectors being smaller than the array of photodetectors; and
detecting light reflected in the field of illumination with the photodetectors.

20. The method set forth in claim 19, further comprising adjusting the optical switch through a sequence of positions aimed different ones of the optical fibers and supplying light to the optical switch at each position

21. The method as set forth in claim 20, further comprising adjusting the optical switch so that each segment of the array of photodetectors is illuminated at least once in the sequence.

22. The method as set forth in claim 20, further comprising, at each position of the sequence, operating the segment of the array of photodetectors for which the field of illumination is positioned to be detected by and disabling the remaining photodetectors of the array of photodetectors.

23. The method as set forth in claim 20, further comprising adjusting the optical switch to deviate from the sequence of positions and return to one of the positions based on previous detection of light at that position.

24. The method as set forth in claim 19, further comprising detecting a scene of light reflected in the field of illumination with each segment and stitching together the scenes from adjacent ones of the segments to form a frame.
